(19) United States
(12) Patent Application Publication
(10) Pub. No.: US 2021/0123766 A1
(43) Pub. Date: Apr. 29, 2021

(54) TRAVEL CONTROL APPARATUS, MOBILE BODY, AND OPERATION SYSTEM

(71) Applicant: KABUSHIKI KAISHA TOSHIBA, Tokyo (JP)

(72) Inventors: Michio YAMASHITA, Inagi Tokyo (JP); Noriyuki HIRAYAMA, Fuchu Tokyo (JP); Hideyuki AISU, Kawasaki Kanagawa (JP); Shizu SAKAKIBARA, Kawasaki Kanagawa (JP)

(73) Assignee: KABUSHIKI KAISHA TOSHIBA, Tokyo (JP)

(21) Appl. No.: 17/010,864

(22) Filed: Sep. 3, 2020

(30) Foreign Application Priority Data
Oct. 29, 2019 (JP) 2019-196650

(51) Int. Cl. G01C 21/36

(52) U.S. Cl. CPC G01C 21/3626

(57) ABSTRACT

According to one embodiment, a travel control apparatus includes a move command data generator configured to acquire a travel route of a first mobile body in a travel area that includes a plurality of first areas and one or more second areas set on at least one of a plurality of travel paths provided among the plurality of first areas, and passing sequence information that defines a sequence in which a plurality of mobile bodies including the first mobile body passes through the first areas included in the travel route, and identify a third area, which is one of the second areas that is located ahead of the first areas on the travel route, and generate move command data for the first mobile body based on the third area and the passing sequence information; and a communicator configured to transmit the move command data to the first mobile body.

### CROSS REFERENCE TO RELATED APPLICATIONS

This application is based upon and claims the benefit of priority from the prior Japanese Patent Application No. 2019-196650, filed on Oct. 29, 2019, the entire contents of which are incorporated herein by reference.

### FIELD

Embodiments described herein relate to a travel control apparatus, a mobile body, and an operation system.

### BACKGROUND

In making a plurality of mobile bodies travel according to an operation plan, if the mobile bodies can travel along a planned travel route according to a timing schedule, operation can be achieved as planned. However, if departure/passage timing of at least any one of the mobile bodies deviates from the plan, contention may occur among the mobile bodies. For example, there may occur a collision or rear-end collision between mobile bodies or a deadlock that disables a mobile body from moving to a desired location.

### BRIEF DESCRIPTION OF THE DRAWINGS

FIG. 1 is a block diagram of an operation planning apparatus and mobile bodies according to a first embodiment;

FIG. 2 is a top view schematically showing how operation of a plurality of mobile bodies are controlled;

FIG. 3A is a diagram showing an example of a collision and FIG. 3B is a diagram showing an example of a deadlock;

FIG. 4 is a diagram showing an example of a travel network;

FIG. 5 is a diagram showing an example of structure information about the travel network;

FIG. 6A is a diagram showing an example of information about a travel path and FIG. 6B is a diagram showing an example of information about reference nodes;

FIG. 7 shows an example in which a virtual area is set on each travel path coupled to a reference area of a travel network;

FIG. 8 is a diagram showing an example of a virtual area DB;

FIG. 9 is a diagram showing an example in which virtual nodes are added to structure information about a travel network;

FIG. 10 is a flowchart showing an operation example of a virtual area setter;

FIG. 11 is a diagram showing an example of operation information;

FIGS. 12A and 12B are diagrams showing an example of operation plans created by an operation plan determination device;

FIG. 13 is a diagram showing a state in which mobile bodies are placed at respective departure points;

FIG. 14 is a diagram showing an example of move command data;

FIG. 15 is a flowchart showing an operation example of the operation planning apparatus shown in FIG. 1;

FIG. 16 is a flowchart showing another operation example of the operation planning apparatus shown in FIG. 1;

FIG. 17 is a flowchart showing an operation example of a mobile body;

FIG. 18 is a block diagram of an operation planning apparatus and mobile bodies according to a second embodiment;

FIG. 19 is a diagram showing an example of move command data generated for AGV0 and AGV1;

FIG. 20 is a flowchart showing an operation example of a mobile body; and

FIG. 21 is a diagram showing a hardware configuration of the operation planning apparatus of FIG. 1.

### DETAILED DESCRIPTION

According to one embodiment, a travel control apparatus includes a move command data generator and a communicator. The move command data generator acquires a travel route of a first mobile body in a travel area that includes a plurality of first areas and one or more second areas set on at least one of a plurality of travel paths provided among the plurality of first areas, and passing sequence information that defines a sequence in which a plurality of mobile bodies including the first mobile body passes through the first areas included in the travel route, and identifies a third area, which is one of the second areas that is located ahead of the first areas on the travel route, and generates move command data for the first mobile body based on the third area and the passing sequence information. The communicator transmits the move command data to the first mobile body.

A typical operation planning system often creates operation plans for guideline type mobile bodies configured to travel along a straight single line such as a rail or tape. When a straight single line is used exclusively, disturbances occur less frequently and mobile bodies can be made to travel almost accurately according to a timing schedule.

On the other hand, autonomous mobile bodies travel freely in a relatively large area by finding an optimum traffic line by identifying their own positions. Examples of autonomous mobile bodies include an automatic guided vehicle (AGV) configured to transport loads in a factory. A travel path of an autonomous mobile body may sometimes be walked or crossed by persons and the mobile body may be equipped with a function to stop by recognizing any person running into the travel path. Also, the mobile body may be equipped with a function to recognize any obstacle lying on the travel path and travel by avoiding the obstacle.

In this way, autonomous mobile bodies are capable of flexible travel, but disturbances often occur in travel environment, making it difficult to travel according to a timing schedule. For example, when moving by avoiding obstacles, the mobile bodies cannot travel according to a timing schedule.

If timing of any of the mobile bodies deviates from the plan, contention can occur among the mobile bodies. For example, there may occur a collision or rear-end collision between mobile bodies. Also, there may occur a deadlock that disables a mobile body from moving to a desired location (e.g., an intersection of travel paths or an end of a travel path).

According to embodiments of the present invention, occurrence of contention among mobile bodies can be avoided even when an operation plan is created for an autonomous mobile body in this way. However, mobile bodies handled in the embodiments are not limited to autonomous mobile bodies, and guideline type mobile bodies are handled as well. The embodiments of the present invention will be described in detail below with reference to the accompanying drawings.

### First Embodiment

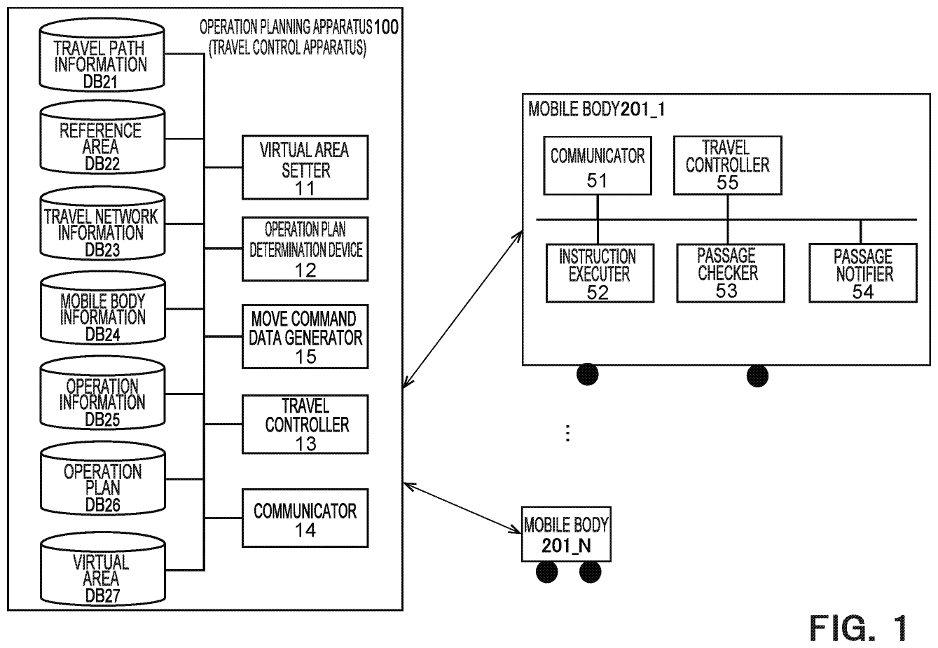

FIG. 1 shows a block diagram of an operation system equipped with an operation planning apparatus (travel control apparatus) and mobile bodies, according to a first embodiment of the present invention. The operation planning apparatus 100 includes a virtual area setter (area setter) 11, an operation plan determination device 12, a travel controller 13, a communicator 14, a move command data generator 15, a travel path information database (DB) 21, a reference area DB 22, a travel network information DB 23, a mobile body information DB 24, an operation information DB 25, an operation plan DB 26, and a virtual area DB 27. Each of mobile bodies 201_1 to 201_N includes a communicator 51, an instruction executer 52, a passage checker 53, a passage notifier 54, and a travel controller 55. A part of or all of elements in the operation planning apparatus or the mobile body can be implemented by circuitry such as a processor, a CPU (central processing unit), or ASIC (Application Specific Integrated Circuit).

If, for example, the a plurality of mobile bodies 201_1 to 201_N travel autonomously in a travel area (travel network), which is a free plane, the operation planning apparatus 100 creates an operation plan for use to control operation in order to keep the plurality of mobile bodies from causing contention such as collisions or deadlocks. The plurality of mobile bodies 201_1 to 201_N are moving vehicles as AGVs, autonomous mobile robots, autonomous vehicles (e.g., self-driving cars), or other mobile bodies capable of autonomous movement.

The plurality of mobile bodies 201_1 to 201_N travel, for example, in a travel area (travel network) of a factory, a storehouse, or facility premises. The plurality of mobile bodies 201_1 to 201_N, for example, carry rechargeable batteries and carry out movements and other motions using electric power stored in the batteries.

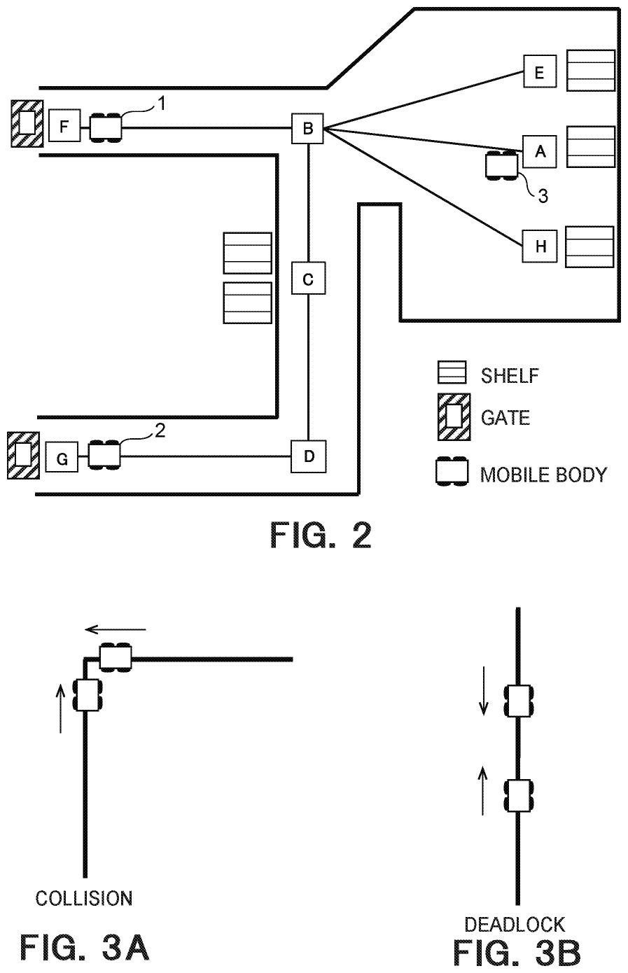

FIG. 2 is a top view schematically showing how operation of a plurality of mobile bodies are controlled in a travel network. A plurality of areas (reference areas) A, B, C, D, E, F, G, and H serving as references are set in the travel network. Between each pair of reference areas, there is a passage (travel path) along which a mobile body can move. In this way, the travel network (travel area) includes a plurality of reference areas as well as a plurality of travel paths among the plurality of reference areas. The reference areas correspond to any locations such as an intersection of travel paths or ends of travel paths. Gates are provided in the reference areas F and G and shelfs are provided in the reference areas A, E, and H. The reference area B corresponds to an intersection of a plurality of travel paths.

Here, each reference area may be located in a specific position or may be an area having a specific range. For example, if the travel network is represented by an X-Y plane, reference areas are identified by X-Y coordinates. When height is taken into consideration, reference areas are identified by X-Y-Z coordinates. Alternatively, each reference area may be identified by a group of a plurality of X-Y coordinates. For example, when the reference area is rectangular, the reference area may be identified by a group of X-Y coordinates of diagonal vertices. It is assumed below that the reference areas are identified by X-Y coordinates.

A plurality of reference areas are managed as reference nodes by being associated with coordinates on map data of the travel network. Reference nodes and corresponding reference areas are denoted by the same reference signs for convenience of explanation. A line (arc) linking each pair of reference areas is managed as a virtual travel path along which a mobile body travels. Reference nodes and virtual travel paths are stored in advance in the form of data. Solid lines and broken lines in FIG. 2 are lines (which correspond to virtual travel paths) linking reference nodes. If two or more mobile bodies can run in parallel between reference nodes, the reference nodes may be linked by two or more lines. Data on reference nodes and virtual travel paths are defined on map data. The map data may be defined in advance in the form of CAD (Computer-Aided Design) drawings or other drawings. Alternatively, if the mobile bodies have a function to create environmental maps using a self-position detection function, an environmental map may be created using this function. Note that the virtual travel paths have the shape of a straight line, a curved line, or a combination thereof.

Mobile bodies 1, 2, and 3 correspond to the mobile bodies 201_1 to 201_3 of FIG. 1. The mobile bodies 1 to 3 have an autonomous travel function. More specifically, the mobile bodies 1 to 3 have a function to generate lines of flow along travel paths among reference areas by themselves and autonomously travel along the formed lines of flow. As an example, when moving from a reference area B to a reference area C, if there is no obstacle between the reference area B and reference area C, a given one of the mobile bodies generates a line segment linking the position of the reference area B and position of the reference area C as a line of flow and autonomously travels along the line of flow. The line of flow generated by the mobile body may or may not coincide with a virtual travel path between the reference node B and reference node C. In moving between the two reference nodes, the mobile body may have a function to travel along a virtual travel path as a recommended travel path and avoid any temporary obstacle found on the virtual travel path.

Note that a travel path that provides leeway for mobile bodies to travel by avoiding any obstacle may be treated as a travel path on which no contention occurs between the mobile bodies. For example, because a travel path BE (travel path between reference area B and reference area E; the same applied hereinafter), travel path BA, travel path BH, and other travel paths in FIG. 2 have enough leeway to allow mobile bodies to go past each other, no contention will occur even if two mobile bodies travel in a head-on direction. For example, one of the mobile bodies waits on the side of the travel path while the other mobile body moves along the line of flow on the travel path. When the second mobile body has passed through the travel path, the first mobile body resumes moving. On the other hand, because the travel path BC does not have enough leeway to allow mobile bodies to go past each other, if two mobile bodies travel in a head-on direction on the travel path, contention such as a collision will occur.

Note that the mobile bodies can move forward, backward, or both forward and backward. The mobile bodies may be rotatable and thus capable of making forward/backward direction changes. Also, the mobile bodies may be capable of moving in directions such as oblique directions other than forward/backward directions.

Sensors configured to detect states of mobile bodies, communication devices configured to communicate with the mobile bodies or both of them may be placed in reference areas, travel paths, shelves, gates, or any other locations. In that case, the sensors are connected to at least either of the operation planning apparatus 100 and communication devices by wire or radio.

Under the control of the operation planning apparatus 100 shown in FIG. 1, each mobile body travels in the travel network according to an assigned operation. For example, the mobile body carries a load received from a gate to another gate. There are cases in which the work of loading or unloading loads from/onto a shelf is carried out in the process of movement. Each mobile body carries out such work by executing instructions contained in move command data given by the operation planning apparatus 100. Note that there can be cases in which the mobile body only moves without conveying loads.

Now, collisions and deadlocks will be described.

FIG. 3A shows an example of a collision and FIG. 3B shows an example of a deadlock. In FIGS. 3A and 3B, travel paths are represented by straight lines for convenience. In FIG. 3A, two mobile bodies travel toward an intersection along two travel paths leading to the intersection, and arrive at the intersection at the same time, resulting in a collision. In FIG. 3B, two mobile bodies travel in opposite directions along the same travel path. If the two mobile bodies can only move forward, the two mobile bodies cannot go backward and thus cannot move to a desired area (intersection, end, or the like), which results in a deadlock.

The contention among mobile bodies is not limited to collisions and deadlocks. For example, the contention also includes a case in which when one or more mobile bodies are waiting at an intersection leading to a travel path, another mobile body is traveling on the travel path.

The operation planning apparatus 100 shown in FIG. 1 allows mobile bodies to travel efficiently without causing contention among the mobile bodies.

The travel network information DB 23 stores structure information about the travel network therein. The structure information about the travel network includes reference nodes and virtual travel paths (arcs) arranged by being associated with map data of travel areas. The reference nodes correspond to reference areas. The reference areas are set at an intersection of a plurality of travel paths or ends of travel paths as an example. However, the reference areas may be set in any locations on travel paths. Examples of such locations include loading/unloading sites and waiting sites.

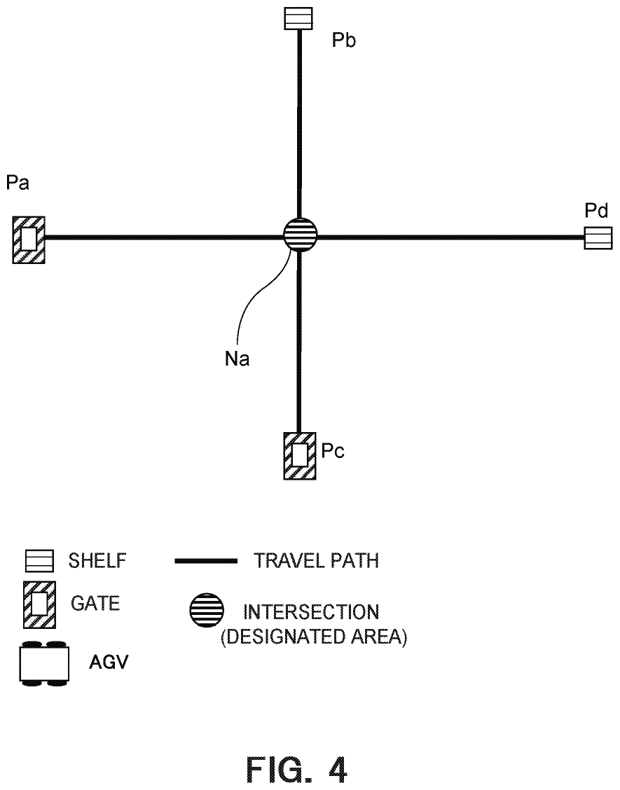

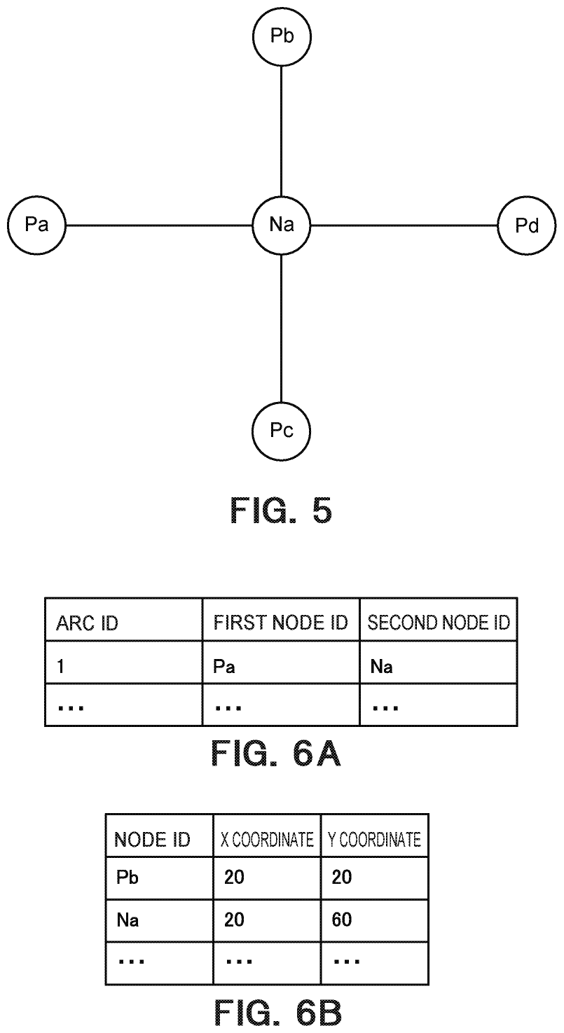

FIG. 4 shows a simple example of a travel network. FIG. 5 shows an example of structure information about the travel network of FIG. 4. The travel network of FIG. 4 includes five reference areas and four travel paths. Here, the travel paths are represented by straight lines for convenience. A reference area Na is an intersection at which the four travel paths intersect and reference areas Pa, Pb, Pc, and Pd are ends of the four travel paths. Shelves are placed in the reference areas Pb and Pd and gates are provided in the reference areas Pa and Pc. The reference areas Pa, Pb, Pc, and Pd can also serve as departure points or arrival points of mobile bodies as an example.

In FIG. 5, virtual travel paths are represented by straight lines coupling (or connecting) reference nodes. Each circle represents a reference node (reference area), and straight lines tying the circles represent arcs (virtual travel paths). The reference nodes are denoted by the same reference signs as the corresponding reference areas.

The travel path information DB 21 stores information about the arcs (virtual travel paths) and information about the reference nodes in the structure information on the travel network as travel path information. The travel path information includes arc IDs (travel path IDs) and IDs of the nodes on opposite ends of each arc (i.e., IDs of the areas on opposite ends of each travel path).

FIG. 6A shows an example of information about each arc (virtual travel path). In FIG. 6A, for example, the ID of the arc between the reference nodes Pa and Na is 1 and the reference nodes on opposite ends of the arc is Pa and Na. Distances between reference nodes (distances of travel paths) may be stored by being associated with the arc IDs. Alternatively, the distance of the travel path may be calculated based on the positions of the reference nodes on opposite sides of each arc. Also, information about structure and arrangement of each travel path including the width, height, material, coefficient of friction, and slope of the travel path may be stored.

The information about the reference nodes in the structure information on the travel network is also stored in the reference area DB 22. For example, reference node IDs, X coordinates, and Y coordinates are stored as the information about the reference nodes. The positions of the reference nodes correspond, for example, to positions (coordinates) of the reference areas corresponding to the reference nodes.

FIG. 6B shows an example of information about reference nodes. For example, the coordinates of the reference node Pb are (X, Y)=(20, 20). That is, the position of the reference area corresponding to the reference node Pb is (X, Y)=(20, 20). Also, the position of the reference node Na is (X, Y)=(20, 60). That is, the position of the reference area Na corresponding to the reference node Na is (X, Y)=(20, 60).

The virtual area setter 11 sets a virtual area on at least one travel path in relation to the reference areas set on the travel network. The virtual area is used to manage a passing sequence of mobile bodies. Here, the virtual area is set on each travel path coupled (or connected) to reference areas, at a position away from the reference areas. That is, in the structure information on the travel network, a virtual node is set on each arc coupled to reference nodes, at a position away from the reference nodes. Virtual areas may be set for all the reference areas on the travel network or specific reference areas such as the reference area corresponding to the intersection, reference areas corresponding to the ends of travel paths, or both reference area corresponding to the intersection and reference areas corresponding to the ends of travel paths. Setting of virtual areas may be specified by a user, who is an operator of the apparatus 100, via an input device. Here, description will be given of a case in which a virtual area is set for the reference area corresponding to the intersection.

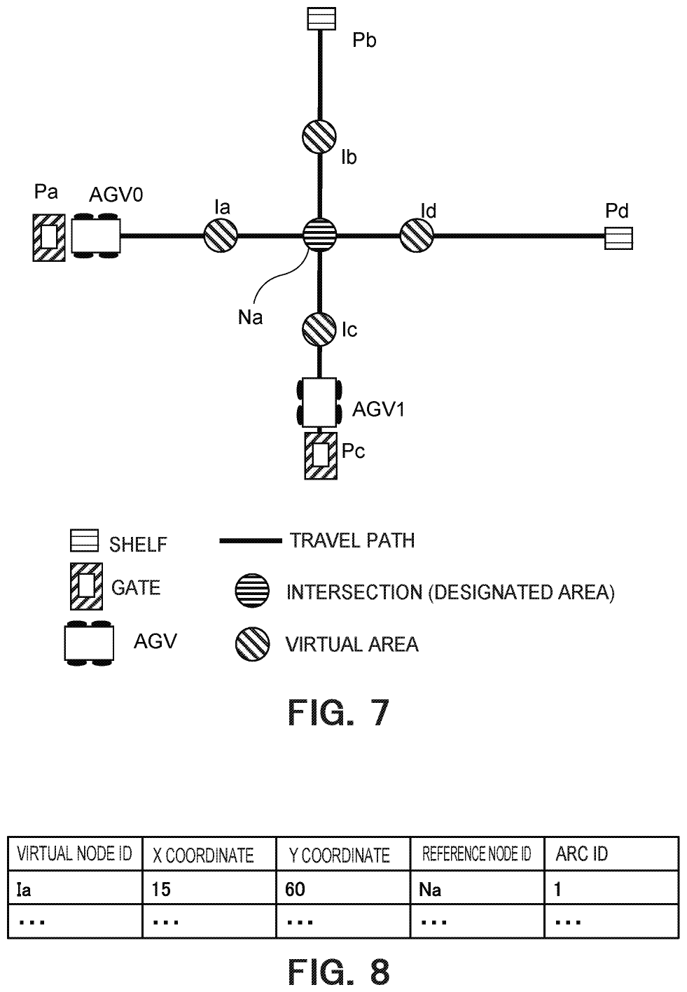

FIG. 7 is a diagram showing an example in which a virtual area is set on each travel path coupled to a reference area (intersection) Na of the travel network of FIG. 4. In this example, virtual areas Ia, Ib, Ic, and Id are set on the respective travel paths coupled to the intersection Na, at positions a predetermined distance away from the intersection Na.

The virtual area DB 27 stores information about the virtual areas set by the virtual area setter 11. Specifically, the virtual area DB 27 stores virtual nodes that represent the virtual areas, by associating the virtual nodes with reference nodes and virtual travel paths (arcs).

FIG. 8 shows an example of the virtual area DB 27. Here, in relation to the reference area (reference node) Na, the virtual area (virtual node) Ia of FIG. 7 is set on a travel path (arc with an ID of 1). The X-Y coordinates of the virtual area Ia are (15, 60).

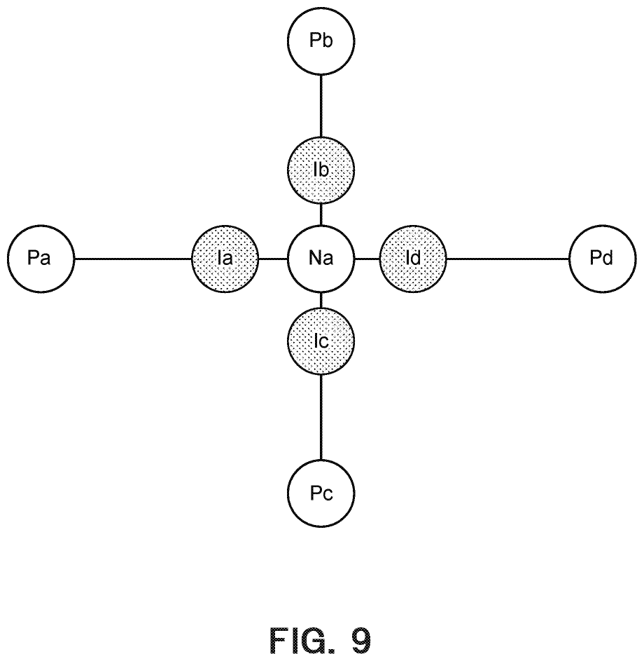

FIG. 9 shows an example in which virtual nodes are added to structure information about the travel network in the example of FIG. 7. On the arcs coupled (or connected) to the reference node Na, virtual nodes Ia, Ib, Ic, and Id are set, respectively, at positions a predetermined distance away from the reference node Na. Note that the virtual nodes are denoted by the same reference signs as the corresponding virtual areas. Virtual nodes can also be set for the reference nodes Pa to Pd. In that case, the virtual nodes can be set, at positions a predetermined distance away from the reference nodes Pa to Pd, for example, on the respective arcs coupled to the reference nodes Pa to Pd.

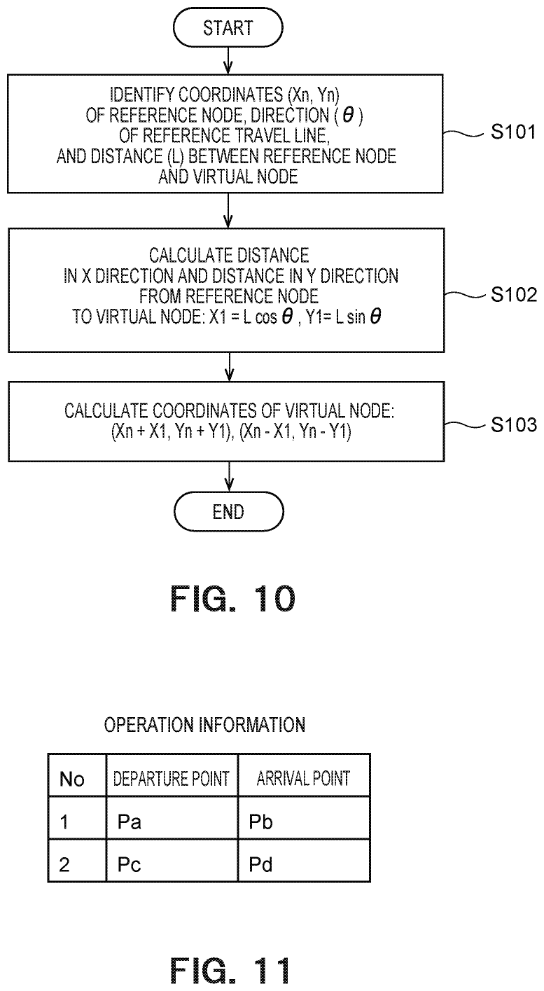

FIG. 10 is a flowchart of an operation example of the virtual area setter 11. In this example, when a virtual node is linear, the virtual node is set at a position a predetermined distance away from a reference node.

In step S101, the reference node for which the virtual node is to be set is identified and the coordinates (Xn, Yn) of the identified reference node are identified. The reference node for which the virtual node is to be set may be a specific reference node (e.g., the reference node corresponding to an intersection) or every reference node or may be specified by the user. Also, the direction (θ) of each arc (virtual travel path) coupled to the identified reference node and the distance (L) between the reference node and virtual node are identified.

The coordinates of the reference node are acquired from the reference area DB 22. The direction θ of the virtual travel path is acquired from the travel path information DB 21. The distance L is a predetermined value. The distance L may be determined according to the structure, placement, and the like of the travel path corresponding to the virtual travel path. Also, the distance L may be determined according to properties (size) of mobile bodies. In that case, a virtual node may be set for each mobile body. Note that the distance L could be determined at random from a given value range.

In step S102, a distance X1 in the X direction and distance Y1 in the Y direction from the reference node to the virtual node are calculated. The distances X1 and Y1 are given by X1=L cos θ and Y1=L sin θ.

In step S103, the coordinates of the virtual node are calculated. The coordinates of the virtual node are calculated from (Xn+X1, Yn+Y1).

The mobile body information DB 24 stores information about one or more mobile bodies. The mobile body information DB 24 stores, for example, positional information about mobile body/bodies. As an example, the positional information about the mobile body/bodies is real-time positional information (the latest positional information). For example, data containing positional information may be received from the mobile body/bodies every predetermined time and the positional information about the mobile body/bodies may be acquired from the received data. Alternatively, when a sensor provided in the travel network detects passage of a mobile body, data informing passage of the mobile body may be received from a communication device connected to the sensor. The positional information about the mobile body/bodies may be positional information about a mobile body on standby yet to be assigned an operation. In that case, a standby position of the mobile body may be learned by receiving data containing the positional information from the communication device connected to the sensor installed on the mobile body on standby or in a waiting place. The data containing the positional information is received by the communicator 14. The positional information may be history information about positions passed by the mobile body so far. Examples of possible information other than positional information include remaining power in the battery carried by the mobile body, information as to whether the mobile body carries a load (when the mobile body is intended to convey loads), and the type and number of loads being conveyed. Examples of information specific to the mobile body include specification information about the mobile body including standard speed, maximum speed, minimum speed, size of the mobile body, and movable direction. If the mobile body is intended to convey loads, possible examples of information also include the working time required for loading/unloading (e.g., the time required to load or unload a predetermined number of loads). The information cited here is only exemplary, and other information may be used.

The operation information DB 25 stores operation information about operations to be assigned to one or more mobile bodies. The operation information includes information about departure points and arrival points. In addition to the departure points and arrival points, the operation information may include details and sequence of work to be carried out by the mobile body/bodies. The operation information may be entered by the user via an input device or acquired from an external apparatus by wired or wireless communication.

FIG. 11 shows an example of operation information. The operation information of FIG. 11 assumes the travel network of FIG. 4.

The example of FIG. 11 shows two pieces of operation information. The first piece of operation information includes a departure point Pa and arrival point Pb. This means that the mobile body starts from the departure point Pa and arrives at the arrival point Pb. The second piece of operation information includes a departure point Pc and arrival point Pd. This means that the mobile body starts from the departure point Pc and arrives at the arrival point Pd.

The operation plan determination device 12 determines the mobile bodies to be assigned individual pieces of operation information in the operation information DB 25 and assigns operations specified by the operation information to the determined mobile bodies. For each mobile body assigned an operation, the operation plan determination device 12 creates a travel plan based on the operation assigned to the mobile body and information about the mobile body stored in the mobile body information DB 24. The travel plan includes the sequence of reference areas to be passed (travel route) and timing to start from or pass through the reference areas (departure/passage timing). The departure/passage timing is identified by the time on a clock provided on the operation planning apparatus 100 as an example.

The travel route and departure/passage timing of each mobile body are determined so as not to cause contention among mobile bodies. That is, if each mobile body travels using the departure/passage timing, no contention will occur. Regarding a method for creating the travel plan, any appropriate method can be used.

The travel route and departure/passage timing that will not cause contention may be determined, for example, by searching for every movement pattern of each mobile body using a simulation. In so doing, standard speed may be used as travel speed of the mobile body. The standard speed may be determined according to properties of the mobile body, properties of the travel path (such as the material of the travel path), the slope of the travel path, or the like. In so doing, by defining contention conditions likely to cause contention, movement patterns that do not meet the contention conditions may be searched for. Examples of the contention conditions include conditions in which two or more mobile bodies travel simultaneously in the same direction or opposite directions on the same travel path.

Alternatively, by first determining the travel route of each mobile body, then departure times (passage times) from reference areas included in the travel route may be determined such that no contention will occur among mobile bodies. The travel route may be such that will minimize the travel distance or travel time from departure point to destination point. In so doing, the departure times (passage times) from the reference areas may be determined such that the contention conditions will not be met.

The travel plan may be created using a method other than the one described above.

The operation plan determination device 12 identifies reference areas included in the travel routes of two or more mobile bodies in common. Of the identified reference areas, an area for use to manage the passing sequence of mobile bodies is determined as a designated area (passage management area). A reference node corresponding to the designated area is referred to as a designated node. There may be either one, or two or more, designated areas. Either all the identified reference areas or only part of them may be designated areas. The user may select designated areas. The operation plan determination device 12 stores information about the designated nodes in the operation plan DB 26, an internal buffer of the operation plan determination device 12, or the like. The reference areas or designated areas correspond to first areas as an example while virtual areas correspond to second, third, or fourth areas as an example.

The operation plan determination device 12 determines the passing sequence of mobile bodies for each designated area (designated node). For example, based on the travel plan, the operation plan determination device 12 compares the departure time in the designated area among the mobile bodies and determines the passing sequence of the mobile bodies in the designated area such that the earlier the departure time, the earlier the order will be. The operation plan determination device 12 generates information indicating a constraint that the mobile bodies need to pass according to the determined passing sequence, i.e., a constraint on the passing sequence in the designated area. This information is referred to as passing sequence information.

The operation plan determination device 12 obtains information about the travel route and the passing sequence information as an operation plan, where information about the travel route is contained in the travel plan of each mobile body (travel route information).

The operation plan DB 26 stores the operation plan (information about the travel route of each mobile body and the passing sequence information) created by the operation plan determination device 12 therein.

A concrete example of operation of the operation plan determination device 12 is shown below. First, the operation plan determination device 12 creates travel plans of AGV0 and AGV1 by assigning the first operation in FIG. 11 to AGV0, and the second operation in FIG. 11 to AGV1.

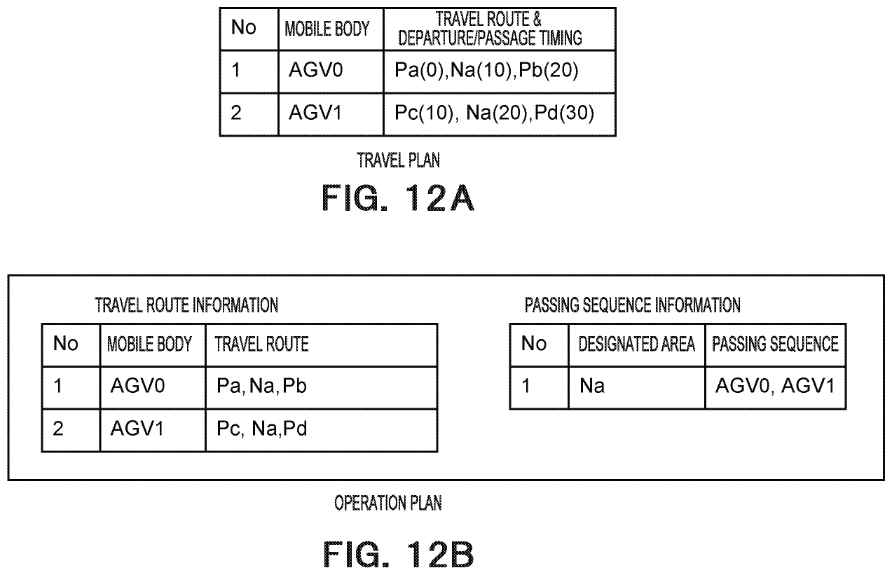

FIG. 12A shows an example of travel plans of AGV0 and AGV1. The travel routes of AGV0 are Pa, Na, and Pb and the departure times on Pa, Na, and Pb are 0, 10, and 20. That is, AGV0 departs from the point Pa at time 0, passes through (departs from) the intersection Na at time 10, and arrives at the point Pb at time 20. The travel routes of AGV1 are Pc, Na, and Pd and the departure times on Pc, Na, and Pd are 10, 20, and 30. That is, AGV1 departs from the point Pc at time 10, passes through (departs from) the intersection Na at time 20, and arrives at the point Pd at time 30. The points Pa to Pd and intersection Na are all reference areas.

Both AGV0 and AGV1 pass through the intersection Na. Therefore, the operation plan determination device 12 identifies Na as a designated area.

Also, the departure time of AGV0 from Na is 10 and the departure time of AGV1 from Na is 20. That is, regarding the passing sequence at the intersection Na, AGV0 passes first and AGV1 passes next. Thus, the operation plan determination device 12 generates passing sequence information including a constraint that AGV0 and AGV1 pass through Na in this order.

The operation plan determination device 12 obtains the travel route information and the created passing sequence information as an operation plan, where the travel route information is included in the created travel plan.

FIG. 12B shows an example of an operation plan obtained by the operation plan determination device 12. The travel routes of AGV0 are Pa, Na, and Pb and the travel routes of AGV1 are Pc, Na, and Pd. In the passing sequence information, the intersection Na is a designated area, and the passing sequence at the intersection Na is identified as follows: AGV0 passes first and AGV1 passes next.

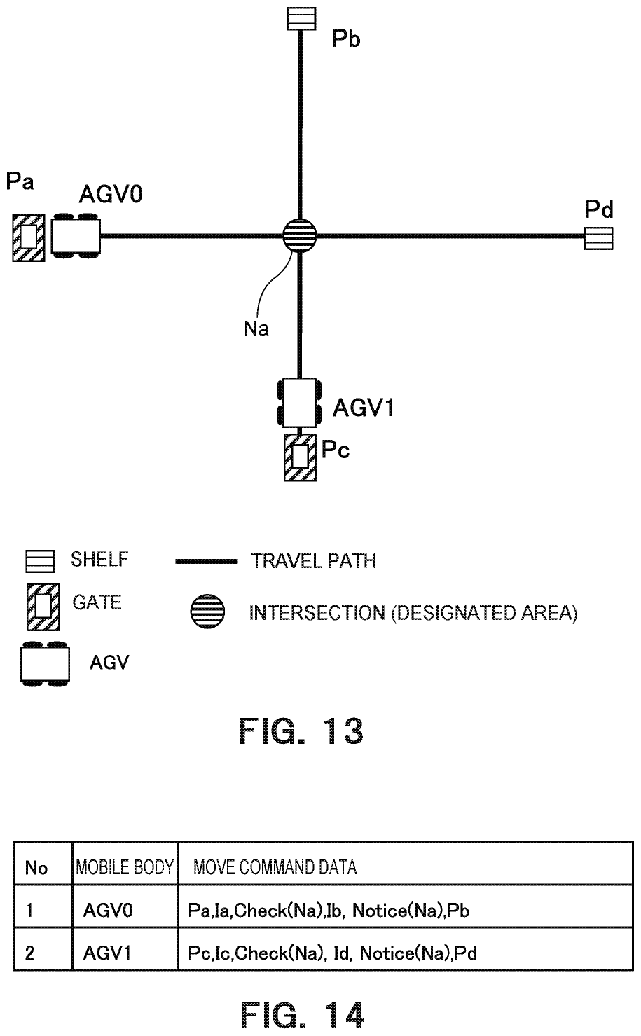

FIG. 13 shows a state in which AGV0 and AGV1 are placed at the respective departure points Pa and Pc in the travel network shown in FIG. 4, the departure points Pa and Pc being indicated in the operation plan. In FIG. 13, the travel paths are represented by straight lines for convenience. Note that before the operation plan is created, AGV0 and AGV1 are located at the respective departure points Pa and Pc, and the operation plan determination device 12 assigns operation information to AGV0 and AGV1 using the information that AGV0 and AGV1 are located at the points Pa and Pc, respectively. However, AGV0 and AGV1 may be placed at the points Pa and Pc, respectively, after being assigned operations.

The move command data generator 15 generates move command data for mobile bodies based on the operation plan (travel route information and passing sequence information) of the mobile bodies in the operation plan DB 26, and the virtual areas set by the virtual area setter 11. That is, the move command data generator 15 acquires the travel routes of the mobile bodies as well as passing sequence information, identifies the virtual areas set on the travel paths on which the mobile bodies travel before passing the designated areas included in the travel routes, and generates move command data for each mobile body based on the set virtual areas and the passing sequence information. The move command data includes a plurality of instructions for the mobile body. As the mobile body executes the plurality of instructions in the move command data in sequence, the operation assigned to the mobile body is carried out. The move command data is generated to avoid contention among a plurality of mobile bodies in designated areas. As the mobile bodies execute the move command data, departure/passage timing in the virtual areas and the designated areas is adjusted, preventing contention in the designated areas. Details will be described below

The move command data generator 15 acquires the travel route of each mobile body based on the operation plan. The move command data generator 15 generates one or more instructions in relation to each of the plurality of reference nodes (reference areas) included in the travel route.

The first reference area on the travel route corresponds to the departure point (start position) of the mobile body according to the present embodiment. Regarding the first reference area, an instruction to move to the departure point is generated (note that if already located at the departure point, the mobile body does not move even if the move instruction is executed).

The last reference area on the travel route corresponds to the arrival point (end position) of the mobile body. Regarding the last reference area, an instruction to move to the arrival point is generated.

Regarding any of reference areas other than the first reference area and last reference area, it is determined whether the reference area is a designated area. If the reference area is not a designated area, an instruction to move to a reference node corresponding to the reference area is generated.

If the reference area is a designated area (here it is assumed that a reference area N is a designated area), a travel path coupled before the reference area N is identified. Specifically, a virtual travel path coupled before the reference node corresponding to the reference area is identified, and a travel path corresponding to the virtual travel path is identified. Then, a virtual area (hereinafter referred to as a virtual area A) set for the reference area N on the identified travel path is identified. Also, on the travel route, a travel path coupled after the reference area N is identified, and a virtual area (hereinafter referred to as a virtual area B) set for the reference area N on the identified travel path is identified.

Then, the following instructions are generated: an instruction to move to the virtual area A (first instruction), an instruction to check whether it is permitted to pass through the reference area N (second instruction), an instruction to move to the virtual area B when it is permitted to pass through the reference area N (third instruction), and an instruction to transmit information to the apparatus 100, indicating that the reference area N has been passed after moving to the virtual area B (fourth instruction). It can also be said that the second instruction is an instruction to check whether it is permitted to start from or pass through the virtual area A and that the third instruction is an instruction to start from or pass through the virtual area A. In this way, four instructions are generated with regard to one reference area N.

The travel controller 13 arranges instructions generated, respectively, for the plurality of reference areas according to arranging sequence of the reference areas, the reference areas being included in the travel route, and thereby generates move command data.

The move command data generator 15 transmits the move command data generated for the mobile body to the mobile body via the communicator 14.

The above operation is performed for all the mobile bodies for which the operation plan has been created.

An execution start time of a first instruction included in the move command data may be added. The execution start time of the first instruction may coincide with the departure time from a reference area in the travel plan. If work carried out by the mobile body is included in the travel plan or travel route, the instruction corresponding to the work is also added to the move command data. Examples of the work include receiving a load from a gate, carrying the received load to a shelf, and loading the load onto the shelf. Unloading the load from the shelf is also included.

FIG. 14 shows an example of move command data generated for AGV0 and AGV1 in the example of an operation plan (travel route information and passing sequence information) in FIG. 12B and the example of the travel network in FIG. 7. Procedures for generating move command data for AGV0 and AGV1 are shown concretely below.

On the travel route of AGV0, since the first reference area Pa corresponds to the departure point, an instruction to move to the point Pa is generated. “Pa” in FIG. 14 means an instruction to move to Pa. Instructions may be written in any desired form. For example, an instruction to move to Pa may be expressed as Move_Pa. Note that in the present example, since AGV0 is already located at the departure point, even if this instruction is executed, AGV0 does not move actually. Therefore, generation of the instruction to move to Pa may be omitted.

On the travel route of AGV0, the place of the second area Na in the passing sequence has been defined by the passing sequence information. Therefore, on the travel route of AGV0, the travel path on which AGV0 travels just before the area Na is identified. On the identified travel path, the virtual area Ia set for the area Na is identified. A specific process involves identifying a virtual travel path on which AGV0 travels just before the reference node Na and identifying a virtual node Ia for the reference node Na on the identified virtual travel path.

Also, on the travel route of AGV0, the travel path on which AGV0 travels just after the area Na is identified. On the identified travel path, the virtual area Ib set for the area Na is identified. A specific process involves identifying a virtual travel path on which AGV0 travels just after the reference node Na and identifying a virtual node Ib for the reference node Na on the identified virtual travel path.

Thus, the following instructions are generated:

an instruction “Ia” to move to the virtual area Ia,

an instruction “Check(Na)” to check whether it is permitted to pass through the designated area Na (start from or pass through the virtual area Ia),

an instruction to move to the virtual area Ib (start from or pass through the virtual area Ia) when it is permitted to pass through the designated area Na, and

an instruction “Notice(Na)” to transmit information to the apparatus 100, indicating that the designated area Na has been passed (the virtual area Ib has been reached) after moving to the virtual area Ib.

“Check(Na)” corresponds to an instruction (a check passage instruction) to check whether the designated area Na has been passed and “Notice(Na)” corresponds to an instruction (a notify passage instruction) to notify completion of passage through the designated area Na.

Note that that AGV0 cannot move further than the virtual area Ia before being permitted to pass through the area (designated node) Na by the travel controller 13 through execution of “Check(Na).” For example, if AGV0 reaches the virtual area Ia before receiving permission to pass through the area Na, AGV0 temporarily stops in the virtual area Ia. On the other hand, in the virtual area Ib, AGV0 does not need to execute “Notice(Na)” upon reaching the virtual area Ib and temporarily stop in the virtual area Ib.

On the travel route of AGV0, since the third area Pb is an arrival point, an instruction “Pd” to move to the arrival point Pb is generated.

If the instructions thus generated are arranged in the order in which the reference areas included in the travel route are arranged, the move command data shown in FIG. 14 is generated for AGV0. Move command data for AGV1 can be generated in a manner similar to AGV0. The travel controller 13 transmits the move command data generated for AGV0 and AGV1 to AGV0 and AGV1 via the communicator 14.

Upon receiving data from a mobile body, inquiring about passage through a designated area (reference area), the travel controller 13 checks the passing sequence information about the designated area. If a notice of completion of passage through the designated area has been received from all the mobile bodies earlier in sequence than the inquiring mobile body or if the inquiring mobile body is the first in the sequence, the travel controller 13 transmits a notice of permission to pass through the designated area (notice of permission to start from or pass through the virtual area) to the inquiring mobile body. In other cases, the travel controller 13 transmits a notice of non-permission to pass through the designated area to the inquiring mobile body. The operation planning apparatus 100 may transmit the notice of non-permission repeatedly until passage through the designated area is permitted. Also, upon receiving a notice of completion of passage through a designated area from the mobile body, the travel controller 13 stores the designated area indicated in the passage-complete notice in the operation plan DB 26, an internal buffer, or the like by associating the designated area with the mobile body that has sent the passage-complete notice.

The communicator 14 conducts wireless or wired communication with the communicator 51 of the mobile body. Regarding a communication scheme, any desired scheme may be used. A private protocol may be defined or a wireless LAN (Local Area Network) protocol defined by IEEE802.11 may be used

The communicator 51 of the mobile body conducts wireless or wired communication with the communicator 14 of the operation planning apparatus 100. Regarding a communication scheme, any desired scheme may be used as described above.

The travel controller 55 of each mobile body controls travel of the mobile body using the instruction executer 52, passage checker 53, and passage notifier 54. On the travel route of the mobile body, before the mobile body passes through the virtual area set on the travel path on which the mobile body travels before traveling on a designated area, the travel controller 55 checks whether the designated area is passable, based on communication with the travel control apparatus. When the designated area is passable, the travel controller 55 performs control such that the mobile body will pass through the virtual area but when the designated area is not passable, the travel controller 55 performs control such that the mobile body will not pass through the virtual area (e.g., will stop in virtual area) until it is confirmed that the designated area is passable. The travel controller 55 acquires move command data from the operation planning apparatus 100 via the communicator 51.

The instruction executer 52 executes the instructions contained in the move command data in sequence, thereby making the mobile body travel along the travel route from the departure point to the arrival point. If time is attached to the first instruction, the mobile body starts executing the instructions when the time comes. If time is not attached, the execution of the instructions is started immediately upon, or some time after, reception of the move command data. The timing to execute the first instruction may be set by a method other than the one described here.

When there is an instruction for the mobile body to move to a reference area or a virtual area, the instruction executer 52 makes the mobile body to move to the reference area or virtual area specified by the instruction. When there is a check passage instruction with regard to a designated area, the instruction executer 52 makes a passage checking inquiry to the operation planning apparatus 100 using the passage checker 53.

The passage checker 53 transmits data inquiring whether passage through the designated area is permitted (passage checking inquiry data) to the operation planning apparatus 100. If a passage permission notice is received, the passage checker 53 provides data or a signal indicating passage permission to the instruction executer 52. When the passage permission data or signal is received, the instruction executer 52 executes the following instruction. That is, the mobile body starts from the virtual area upstream of the designated area (i.e., the virtual area in which the mobile body is temporarily stopped or for which the mobile body is currently heading). In the process of moving to the next area (virtual area or reference area), the mobile body will pass through the designated area. On the other hand, when a notice of non-permission for passage or no response is received from the operation planning apparatus 100, the passage checker 53 waits until a passage permission notice is received or repeatedly transmits passage permission inquiry data at regular time intervals. Alternatively, the operation planning apparatus 100 may repeatedly transmit a non-permission notice until permitting passage.

When there is a notify passage instruction with regard to a designated area, the instruction executer 52 sends a passage-complete notice to the operation planning apparatus 100 using the passage notifier 54. The passage notifier 54 transmits a notice to the operation planning apparatus 100, indicating that the designated area specified by the instruction has been passed.

By taking AGV0 and AGV1 as an example, operation of mobile bodies will be described below.

AGV0 receives the first item of move command data shown in FIG. 14 and executes the instructions in the received move command data in sequence. AGV0 receives the second item of move command data shown in FIG. 14 and executes the instructions in the received move command data in sequence. Here, for the sake of explanation, it is assumed that after receiving move command data, AGV0 and AGV1 start executing instructions simultaneously.

### AGV0

AGV0, which executes an instruction “Pa” but is already located in the area Pa, executes the next instruction “Ia” (or may skip the first instruction). By executing the instruction “Ia,” AGV0 moves toward the virtual area Ia. Upon or before arriving at the virtual area Ia, AGV0 executes the instruction “Check(Na).” If AGV0 has not yet received permission to pass through Ia at the time of arrival at the virtual area Ia, AGV0 temporarily stops in the virtual area Ia. By executing the instruction “Check(Na),” AGV0 checks whether it is permitted to pass through the area Na. Specifically, AGV0 transmits data inquiring whether passage through the area Na (passage through or start from the virtual area Ia) is permitted (passage checking inquiry data) to the operation planning apparatus 100. The travel controller 13 of the operation planning apparatus 100 checks the place of AGV0 in the passing sequence based on the passing sequence information. Since the AGV0 is placed first in the passing sequence, the travel controller 13 transmits a notice of permission to pass through the area Na (notice of permission to pass through or start from the virtual area Ia) to AGV0. Being permitted to pass through the area Na (pass through or start from the virtual area Ia), AGV0 executes a next instruction Ib and thereby heads toward the virtual area Ib. In the process of heading toward the virtual area Ib, AGV0 passes through the area Na. Upon arriving at the virtual area Ib, AGV0 executes a next instruction “Notice(Na)” and thereby transmits a passage-complete notice to the operation planning apparatus 100, indicating that AGV0 has passed the area Na (arrived at the virtual area Ib). Next, AGV0 executes a next instruction “Pb” and thereby moves to the area Pb. Upon arriving at the area Pb, AGV0 finishes operation. For example, AGV0 waits until next move command data is received from the operation planning apparatus 100.

### AGV1

AGV1, which executes an instruction “Pc” but is already located in the area Pc, executes a next instruction “Ic” (or may skip the first instruction). By executing the instruction “Ic,” AGV1 heads toward the virtual area Ic. Upon or before arriving at the virtual area Ic, AGV1 executes the instruction “Check(Na).” If AGV1 has not yet received permission to pass through Ic at the time of arrival at the virtual area Ic, AGV1 temporarily stops at the virtual area Ic. By executing the next instruction “Check(Na),” AGV1 checks whether it is permitted to pass through the area Na. Specifically, AGV1 transmits data inquiring whether passage through the area Na (passage through or start from the virtual area Ic) is permitted (passage checking inquiry data) to the operation planning apparatus 100. The travel controller 13 of the operation planning apparatus 100 checks the place of AGV1 in the passing sequence based on the passing sequence information. Since the AGV1 is placed second in the passing sequence, the travel controller 13 checks whether AGV0 in the first place has passed through the area Na. If a notice of completion of passage through the area Na has been received from AGV0, it is determined that AGV0 has passed through the area Na. In this case, the travel controller 13 transmits a notice of permission (notice of permission to pass through or start from the virtual area Ic) to AGV1, permitting AGV1 to pass through the area Na. On the other hand, if a notice of completion of passage through the area Na has not been received from AGV0, the travel controller 13 determines that AGV0 has not passed through the area Na yet, and transmits a non-permission notice or no response to AGV1. When permitted to pass through the area Na (permitted to pass through or start from the virtual area Ia), AGV1 executes a next instruction “Id” and thereby heads toward the virtual area Id. If a non-permission notice or no response is received from the operation planning apparatus 100, AGV1 remains waiting in the virtual area Ic and transmits inquiry data again after a predetermined time. Alternatively, AGV1 continues waiting in the virtual area Ic until a permission notice is received from the operation planning apparatus 100. In the process of heading toward the virtual area Id, AGV1 passes through the area Na. Upon arriving at the virtual area Id, AGV1 executes a next instruction “Notice(Na)” and thereby transmits a passage-complete notice to the operation planning apparatus 100, indicating that AGV1 has passed the area Na (arrived at the virtual area Id). AGV1 executes the next instruction “Pd” and thereby moves to the area Pd. Upon arriving at the area Pd, AGV1 finishes operation. For example, AGV1 waits until next move command data is received from the operation planning apparatus 100.

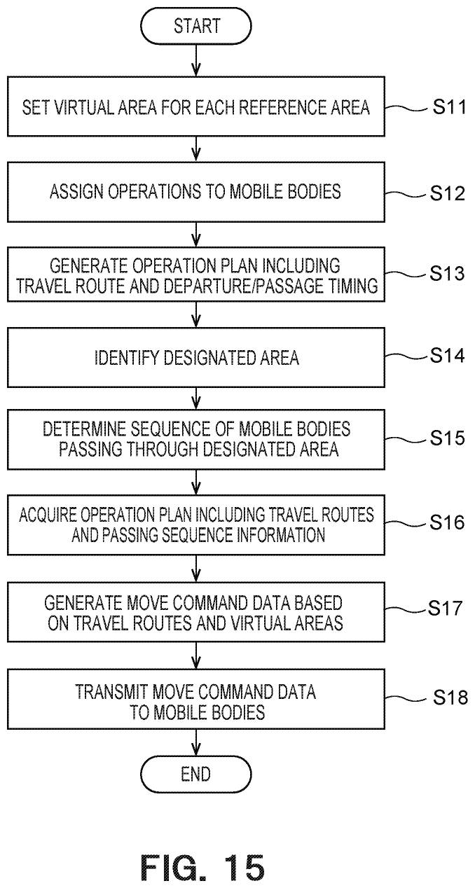

FIG. 15 is a flowchart of an operation example of the operation planning apparatus 100. Based on information stored in the travel network information DB 23, reference area DB 22, and travel path information DB 21, the virtual area setter 11 sets a virtual area for each reference area in the travel network. A specific process involves setting a virtual node for each reference node indicated in the structure information about the travel network (S11).

Based on information stored in the operation information DB 25 and mobile body information DB 24, the operation plan determination device 12 assigns operations indicated by the operation information to mobile bodies (S12). Based on the travel plan assigned to the mobile bodies, the operation plan determination device 12 generates an operation plan of each mobile body (S13). The travel plan includes a travel route and departure/passage timing as an example. Based on the travel route of each mobile body, the operation plan determination device 12 identifies a reference area passed by a plurality of mobile bodies in common (S14). The identified reference area is set as a designated area. The operation plan determination device 12 determines the sequence of the mobile bodies passing through the designated area (S15). As an example, based on the departure/passage timings of the plurality of mobile bodies in the designated area, the order of the mobile bodies is determined according to the order in which the departure/passage timings come. The operation plan determination device 12 obtains information about the travel routes of the respective mobile bodies (travel route information) and information about constraints on the passing sequence in the designated area (passing sequence information) as an operation plan (S16).

Based on the travel route information about each mobile body in the operation plan and information about the virtual areas set by the virtual area setter 11, the travel controller 13 generates move command data for each mobile body (S17). More specifically, with regard to the first reference area and last reference area in the travel route, the travel controller 13 generates an instruction to move to the first reference area and an instruction to move to the last reference area. Regarding any reference area between the first reference area and last reference area, the travel controller 13 generates an instruction to move to the virtual area (designated as a virtual area A) ahead of the reference area, a check passage instruction with regard to the reference area, an instruction to move to a virtual area (designated as a virtual area B) behind the reference area (instruction to start from or pass through the virtual area A) after passage permission is obtained, and an instruction to transmit a notice of completion of passage through the reference area upon arrival at the virtual area B. The travel controller 13 generates move command data by arranging the instructions generated with regard to the respective reference areas included in the travel route, according to the arranging sequence of the reference areas. The travel controller 13 transmits the move command data generated for the mobile bodies to the mobile bodies via the communicator 14 (S18).

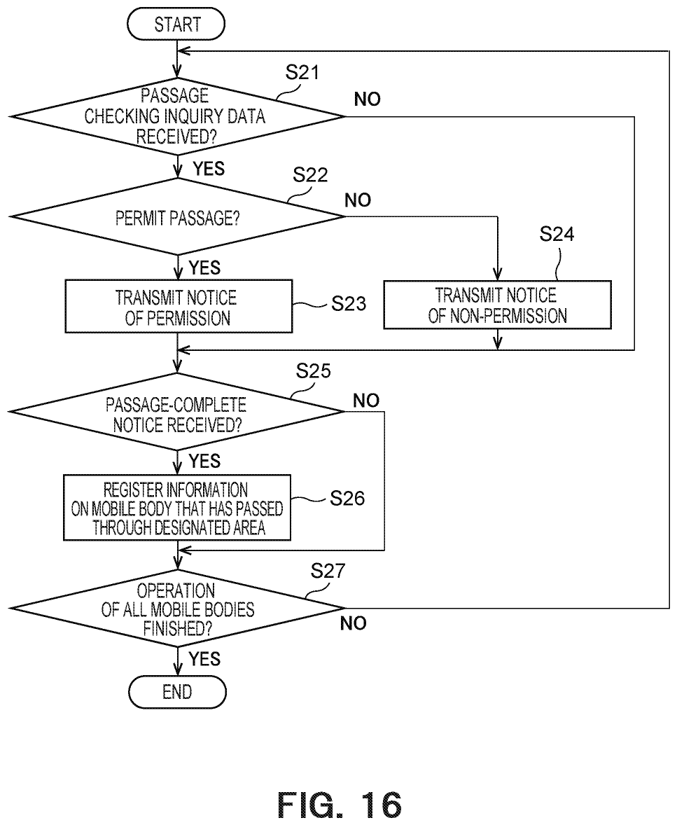

FIG. 16 is a flowchart showing an operation example of operation performed after move command data is transmitted to mobile bodies. The travel controller 13 determines whether passage checking inquiry data with regard to a designated area (reference area) has been received from a mobile body (S21). If no inquiry data has been received (NO in S21), the travel controller 13 goes to step S25. If inquiry data has been received (YES in S21), the travel controller 13 checks the passing sequence information on the designated area indicated in the inquiry data. The travel controller 13 identifies all the mobile bodies earlier in sequence than the inquiring mobile body and determines whether a notice of completion of passage through the designated area has been received from all the identified mobile bodies or whether the inquiring mobile body is the first in the sequence (S22). If a passage-complete notice has been received from all the mobile bodies or if the inquiring mobile body is the first in the sequence, the travel controller 13 transmits a notice of permission to pass through the designated area (notice of permission to start from or pass through the virtual area) to the inquiring mobile body (S23). In other cases, the travel controller 13 transmits a notice of non-permission to pass through the designated area to the inquiring mobile body (S24).

The travel controller 13 determines whether a notice of completion of passage through a designated area has been received from any mobile body (S25). If a passage-complete notice has been received (YES in S25), the travel controller 13 stores the designated area indicated in the passage-complete notice in the operation plan DB 26, an internal buffer, or the like by associating the designated area with the mobile body that has sent the passage-complete notice (S26). If a passage-complete notice has not been received (NO in S25), the travel controller 13 goes to step S21. If an operation-complete notice has been received from all the mobile bodies, the travel controller 13 finishes the present process (YES in S27). If there is any mobile body that has not completed operation, the travel controller 13 returns to step S21.

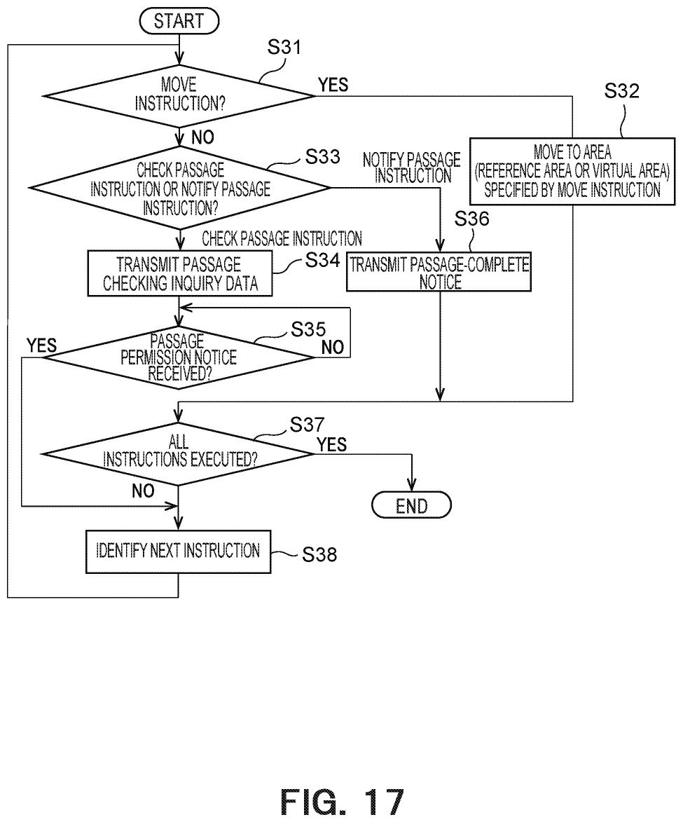

FIG. 17 is a flowchart showing an operation example of a mobile body that has received move command data. The instruction executer 52 of the mobile body identifies the plurality of instructions in the move command data in sequence from the beginning. The instruction executer 52 checks whether the identified instruction is a move instruction (S31). If the instruction is a move instruction, the mobile body moves to the area (reference area or virtual area) specified by the move instruction (S32). After the mobile body moves to the specified area, the instruction executer 52 determines whether all the instructions have been executed (S37). Note that when the mobile body is located at the initial departure point (start point), if the first instruction is an instruction to move to the start point, there is no need to move.

If it is determined in step S37 that not all the instructions have been executed (NO), the instruction executer 52 identifies the next instruction (S38) and returns to step S31. If all the instructions have been executed (YES), the instruction executer 52 finishes the present process.

If the identified instruction is not a move instruction (NO in S31), the instruction executer 52 determines whether the instruction is a check passage instruction with regard to a designated area or a notify passage instruction with regard to a designated are (S33).

If the instruction is a check passage instruction, the passage checker 53 transmits passage checking inquiry data with regard to a designated area to the operation planning apparatus 100 (S34). If a passage permission notice is received from the operation planning apparatus 100 (YES in S35), the instruction executer 52 goes to step S38. If no permission notice is received (NO in S35), the instruction executer 52 waits until a permission notice is received. Alternatively, the instruction executer 52 may repeatedly transmit the inquiry data at regular time intervals until a permission notice is received. Note that possible cases in which no permission notice is received include a case in which a non-permission notice is received and a case in which no response is received.

If the identified instruction is a notify passage instruction, the passage notifier 54 transmits a notice of completion of passage through the designated area to the operation planning apparatus 100 (S36). An acknowledgment may be set to be received from the operation planning apparatus 100 after the transmission. In that case, the passage notifier 54 waits until an acknowledgment is received. Alternatively, if no acknowledgment is received after a lapse of a definite period of time, a passage-complete notice may be retransmitted. Then, the instruction executer 52 goes to step S37.

Although in the present embodiment, virtual areas are set in advance for the reference areas in the travel network, virtual areas may be created for the reference areas included in travel routes during creation of an operation plan.

In the present embodiment, after the mobile body passes through a designated area, a passage-complete notice is transmitted in a virtual area passed right after the designated area. When positional information of a mobile body is managed by the apparatus 100 in real time, passage of the mobile body through a designated area may be detected on the side of the apparatus 100. In that case, transmission of a passage-complete notice from the mobile body (i.e., transmission of the fourth instruction) may be omitted.

Although in the present embodiment, a virtual area is set on a travel path coupled to a designated area, this is not restrictive. For example, in a situation where a first end of a travel path is coupled to a designated area on one end and coupled to another reference area on another end, a virtual area for the designated area may be set on another travel path coupled to the other reference area. This configuration is possible, for example, when there is no need for the other reference area to manage the passing sequence of mobile bodies and the other reference area is not set as a designated area.

Although in the present embodiment, a passing sequence is generated regarding a reference area (reference node) passed by a plurality of mobile bodies, a passing sequence may be generated regarding a reference area (reference node) passed by only a single mobile body. Also, a reference area passed by only a single mobile body may be set as a designated area.

Thus, according to the present embodiment, control is performed such that a given mobile body will start from or pass through the virtual area right before a designated area only if all the other mobile bodies set to pass prior to the given mobile body according to passing sequence information have passed through the designated area. This ensures the passing sequence of mobile bodies in the designated area. Thus, operation can be carried out by avoiding contention among mobile bodies regardless of disturbances and the like in the travel environment.

### First Variation

In the embodiment described above, a travel plan has been created by calculating the travel routes of mobile bodies and the departure times from the reference areas included in the travel routes. Using another plan, a travel plan may be created by calculating the travel routes of a plurality of mobile bodies and the passing sequences of the mobile bodies in the reference areas included in the travel routes of the plurality of mobile bodies in common. In that case, there is no need to calculate the departure times from the reference areas. Information on the passing sequences in the reference areas can be used, as it is, as passing sequence information in an operation plan.

### Second Variation

Reference areas are not limited to intersections, and may be other places where mobile bodies stop, such as loading/unloading sites, charging sites, and waiting sites of the mobile bodies. Reference areas may also be places where roads become narrow, such as change points from a two-lane route to a one-lane route. Also, reference areas may be locations where a travel path slope changes. Also, reference areas may be locations such as corners where mobile bodies change speed. It is conceivable to set places where mobile bodies could collide with each other as reference areas and set virtual areas for the reference areas to control passing sequences properly. Also, places that will become departure points of mobile bodies and places that will become destination points of operation information may be set as reference areas. Also, current positions of mobile bodies may be set as reference areas.

### Second Embodiment

In the first embodiment, start from or passage through the virtual area right before a designated area is controlled (a passage checking inquiry and transmission of a passage-complete notice are carried out) through communication between a mobile body and the operation planning apparatus 100. In a second embodiment, start from or passage through the virtual area right before a designated area is controlled through communication among mobile bodies. The present embodiment adopts a setup in which a right to pass (right of passage) through a designated area is exchanged between mobile bodies and only the mobile body having the right of passage is allowed to pass through the designated area (start from or pass through the virtual area right before the designated area). The present embodiment will be described in detail below. Descriptions similar to the first embodiment will be omitted.

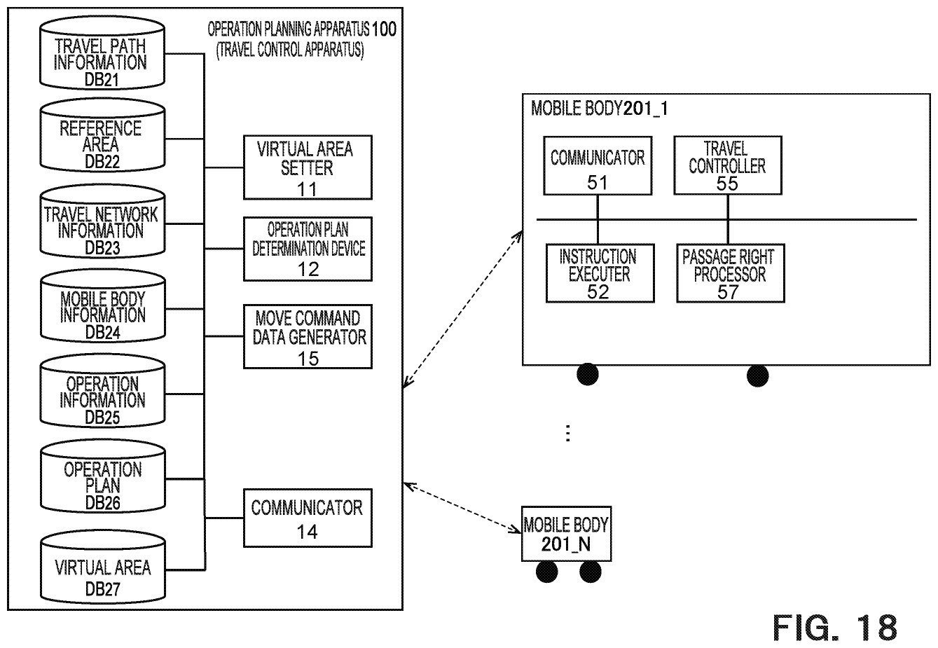

FIG. 18 shows a block diagram of an operation system equipped with an operation planning apparatus (travel control apparatus) and mobile bodies, according to the second embodiment. The operation planning apparatus 100 has a configuration similar to the first embodiment except that the travel controller 13 is not provided. Each of the mobile bodies 201_1 to 201_N includes a passage right processor 57, but does not include the passage checker 53 and passage notifier 54 of the first embodiment. The communicators 51 of the mobile bodies 201_1 to 201_N communicate with one another as well as with the operation planning apparatus 100. Regarding a scheme of communication among the mobile bodies, any desired scheme, such as a private protocol or wireless LAN protocol, may be used.

Operations of the virtual area setter 11 and operation plan determination device 12 of the operation planning apparatus 100 are the same as the first embodiment.

The move command data generator 15 generates move command data for mobile bodies based on the mobile body operation plan (travel route information and passing sequence information) in the operation plan DB 26 and the virtual areas set by the virtual area setter 11. As with the first embodiment, the move command data is generated to avoid contention among a plurality of mobile bodies in designated areas, but the configuration of the generated move command data differs from the first embodiment. Details will be described below.

Based on the operation plan, the move command data generator 15 identifies a designated area among the plurality of reference nodes (reference areas) included in the travel route. With regard to the designated area thus identified, the move command data generator 15 identifies the mobile body placed first in sequence, based on the passing sequence information. The move command data generator 15 generates an instruction (a give passage right instruction) to give the identified mobile body itself a right of passage through the designated area. The give passage right instruction is expressed as “SendRight(argument 1, argument 2).” Argument 1 is an ID of the designated area and argument 2 is an ID of the mobile body. The mobile body that executes the give passage right instruction gives the right of passage through the designated area specified by argument 1 to the mobile body specified by argument 2. Giving a right of passage means sending data containing information that indicates the right of passage. Here, because the right of passage is given to the mobile body itself that executes the give passage right instruction, the ID specified by argument 2 is the ID of the mobile body itself. The ID specified by argument is the ID of the designated area identified above.

The move command data generator 15 identifies the first reference area on the travel route. According to the present embodiment, the first reference area corresponds to the departure point (start position) of the mobile body. Regarding the first reference area, instruction to move to the departure point is generated as with the first embodiment.

The move command data generator 15 identifies the last reference area on the travel route. The last reference area on the travel route corresponds to the arrival point (end position) of the mobile body. Regarding the last reference area, an instruction to move to the arrival point is generated as with the first embodiment.

Regarding any of reference areas other than the first reference area and last reference area, it is determined whether the reference area is a designated area. If the reference area is not a designated area, an instruction to move to a reference node corresponding to the reference area is generated.

If the reference area is a designated area (here it is assumed that a reference area N is a designated area), a travel path coupled before the reference area N is identified. Then, a virtual area (hereinafter referred to as a virtual area A) set for the reference area N on the identified travel path is identified. Also, on the travel route, a travel path coupled after the reference area N is identified, and a virtual area (hereinafter referred to as a virtual area B) set for the reference area N on the identified travel path is identified.

Then, the following instructions are generated: an instruction to move to the virtual area A (first instruction), an instruction to check whether the mobile body itself has a right of passage through the reference area N (check passage right instruction; second instruction), an instruction to move to the virtual area B when the mobile body has a right of passage through the reference area N (third instruction), and an instruction to give the right of passage through the reference area N to the mobile body placed next in sequence in the passing sequence information after moving to the virtual area B (a transfer passage right instruction; fourth instruction). If there is no mobile body placed next in sequence (if the mobile body itself is the last in the sequence), the mobile body ID, which is an argument to the transfer passage right instruction, is set to “NULL” (no mobile body is specified). The check passage right instruction is expressed as “HaveRight(argument).” The argument of the check passage right instruction is the ID of a reference area (designated area). The mobile body that executes the check passage right instruction checks whether the mobile body itself has the right of passage through the designated area specified as an argument (i.e., whether the mobile body is permitted to pass through the designated area). It can be said that the second instruction instructs the mobile body to check whether the mobile body is permitted to start from or pass through the virtual area A. It can be said that the third instruction instructs the mobile body to start from or pass through the virtual area A. It can be said that the fourth instruction permits the mobile body placed next in sequence to pass through the reference area N. In this way, four instructions are generated with regard to one reference area N.

The travel controller 13 arranges instructions generated, respectively, for the plurality of reference areas according to the arranging sequence of the reference areas, the reference areas being included in the travel route, and thereby generates move command data. Regarding the move command data for the mobile body that passes through a designated area earlier than any other mobile body, a give passage right instruction regarding the designated area is placed at the beginning of the move command data (before a start instruction). If there are a plurality of designated areas through which a certain mobile body passes earlier than any other mobile body, a plurality of give passage right instructions regarding the plurality of designated areas are placed at the beginning of the move command data. In so doing, the arranging sequence of the plurality of give passage right instructions may be arbitrary.

The move command data generator 15 transmits the move command data generated for the mobile body to the mobile body via the communicator 14.

The above operation is performed for all the mobile bodies for which the operation plan has been created.

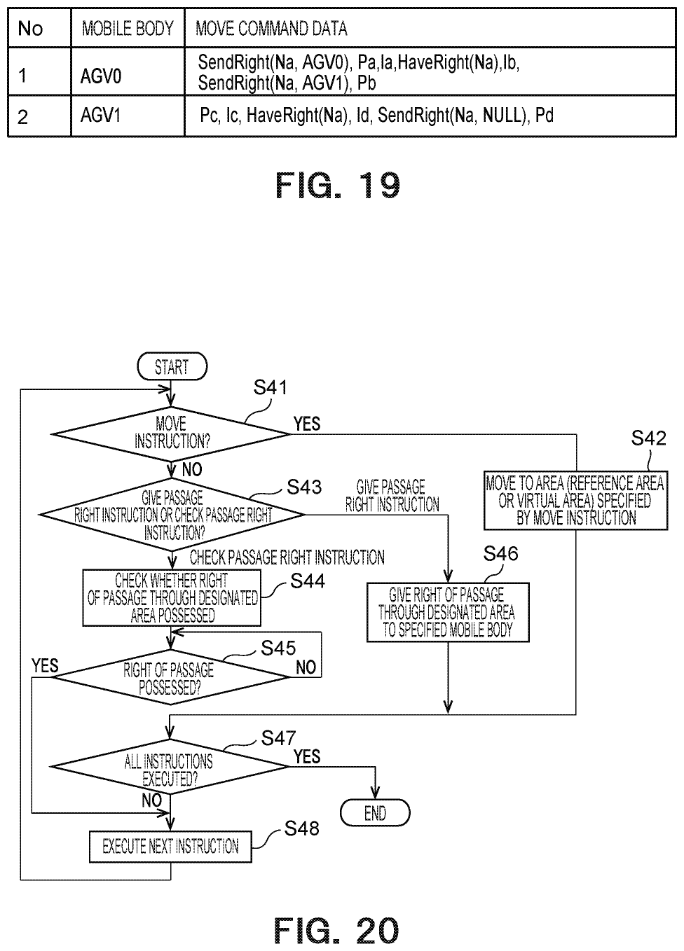

FIG. 19 is a diagram showing an example of move command data generated for AGV0 and AGV1 in the example of the operation plan (travel route information and passing sequence information) in FIG. 12B and the example of the travel network in FIG. 7. Procedures for generating move command data for AGV0 and AGV1 are shown concretely below.

On the travel routes of AGV0 and AGV1, the designated area Na is identified. The mobile body placed first in the passing order in the designated area Na is AGV0 according to the passing sequence information. Thus, an instruction (a give passage right instruction) “SendRight(Na, AGV0)” is generated, instructing AGV0 to give a right of passage through the designated area Na. On the travel routes of AGV0 and AGV1, there is no designated area other than Na.

On the travel route of AGV0, since the first reference area Pa corresponds to the departure point, an instruction to move to the point Pa is generated.

On the travel route of AGV0, the second area Na is a designated area whose place in the passing sequence has been defined by the passing sequence information. Therefore, on the travel route of AGV0, the travel path on which AGV0 travels just before the area Na is identified. On the identified travel path, the virtual area Ia set for the area Na is identified.

Also, on the travel route of AGV0, the travel path on which AGV0 travels just after the area Na is identified. On the identified travel path, the virtual area Ib set for the area Na is identified.

Thus, the following instructions are generated:

an instruction “Ia” to move to the virtual area Ia,

an instruction “HaveRight(Na)” to check whether it is permitted to check for a right of passage through the designated area Na (start from or passage through the virtual area Ia),

an instruction “Ib” to move to the virtual area Ib (start from or pass through the virtual area Ia) when the mobile body itself has a right of passage through the designated area Na, and

an instruction “SendRight(Na, AGV1)” to give the right of passage through the designated area Na to the mobile body (AGV1) placed next in sequence, after moving to the virtual area Ib.

On the travel route of AGV0, since the third area Pb is an arrival point, an instruction “Pb” to move to the arrival point Pb is generated.

If the instructions thus generated are arranged in the order in which the reference areas included in the travel route are arranged and “SendRight(Na, AGV0)” is placed at the beginning, the move command data shown in FIG. 19 is generated for AGV0. Note that the placement of “SendRight(Na, AGV0)” at the beginning is exemplary, and “SendRight(Na, AGV0)” may be placed at any position as long as it is placed ahead of the instruction “HaveRight(Na)” to check for a right of passage through the designated area specified by “SendRight.”

Move command data for AGV1 can be generated in a manner similar to AGV0.

Specifically, on the travel route of AGV1, since the first reference area Pc corresponds to the departure point, an instruction to move to the point Pc is generated.

On the travel route of AGV1, the second area Na is a designated area whose place in the passing sequence has been defined by the passing sequence information. Therefore, on the travel route of AGV1, the travel path on which AGV1 travels just before the area Na is identified. On the identified travel path, the virtual area Ic set for the area Na is identified.

Also, on the travel route of AGV1, the travel path on which AGV1 travels just after the area Na is identified. On the identified travel path, the virtual area Id set for the area Na is identified.

Thus, the following instructions are generated:

an instruction “Ic” to move to the virtual area Ic,

an instruction “HaveRight(Na)” to check whether it is permitted to check for a right of passage through the designated area Na (start from or passage through the virtual area Ic),

an instruction “Id” to move to the virtual area Id (start from or pass through the virtual area Ic) when the mobile body itself has a right of passage through the designated area Na, and

an instruction “SendRight(Na, NULL)” to give the right of passage through the designated area Na to the mobile body placed next in sequence, after moving to the virtual area Ic. Since there is no mobile body placed next in sequence, argument 2 of “SendRight” is set to “NULL.”

Note that AGV1 cannot move further than the virtual area Ic before it is confirmed by the execution of “HaveRight(Na)” that AGV1 has the right of passage through the designated area Na. For example, if AGV1 reaches the virtual area Ic before acquiring the right of passage through the area Na, AGV1 temporarily stops at the virtual area Ic. On the other hand, in the virtual area Id, AGV1 does not need to execute “SendRight(Na, NULL)” upon reaching the virtual area Id and temporarily stop at the virtual area Id.

The travel controller 13 transmits the move command data generated for AGV0 and AGV1 to AGV0 and AGV1 via the communicator 14.

The travel controller 55 of each mobile body controls travel of the mobile body using the instruction executer 52 and passage right processor 57. On the travel route of the mobile body, before the mobile body passes through the virtual area set on the travel path on which the mobile body travels before traveling on a designated area, the travel controller 55 of the mobile body checks whether the designated area is passable, based on communication with other mobile bodies. When the designated area is passable, the travel controller 55 performs control such that the mobile body will pass through the virtual area but when the designated area is not passable, the travel controller 55 performs control such that the mobile body will not pass through the virtual area (e.g., will stop in virtual area) until it is confirmed that the designated area is passable. The travel controller 55 acquires move command data from the operation planning apparatus 100 via the communicator 51.

The instruction executer 52 executes the instructions contained in the move command data in sequence, thereby making the mobile body travel along the travel route from the departure point to the arrival point.

When there is an instruction for the mobile body to move to a reference area or a virtual area, the instruction executer 52 makes the mobile body to move to the reference area or virtual area specified by the move instruction.

When there is a give passage right instruction, using the passage right processor 57, the instruction executer 52 performs the process of giving a right of passage through the designated area specified by the give passage right instruction to the mobile body specified by the give passage right instruction.

For example, the process uses a frame that includes an address field and a notification field configured to store the ID of the designated area in relation to which a right of passage is given. The passage right processor 57 stores an ID (such as an address) of the specified mobile body in the address field of the frame while storing the ID of the designated area in relation to which the right of passage is given in the notification field and thereby generates the frame. The generated frame is transmitted via the communicator 51. This makes it possible to give the mobile body specified by the address field the right of passage through the designated area specified by a designated-area field. An acknowledgment of receipt of the frame may be set to be received from the mobile body specified by the address. If no acknowledgment is received, the frame may be retransmitted at regular time intervals. This increases reliability in giving the right of passage.

When a frame is received from another mobile body, the passage right processor 57 checks whether the frame is addressed at the local mobile body to which the passage right processor 57 belongs. When the frame is addressed at the local mobile body, the passage right processor 57 reads the ID of the designated area out of the notification field. The passage right processor 57 recognizes that the local mobile body has acquired the right of passage through the designated area. The passage right processor 57 may store information about the designated area for which the local mobile body has the right of passage in an internal buffer of the passage right processor 57 or in an accessible storage. The storage may be placed either inside the mobile body or in an external device accessible by wired or wireless communication.

When there is a check passage right instruction, using the passage right processor 57, the instruction executer 52 performs the process of checking whether the local mobile body has the right of passage through the designated area specified by the give passage right instruction. When the local mobile body has the right of passage, the instruction executer 52 executes a next instruction. That is, the mobile body starts from the virtual area upstream of the designated area (i.e., the virtual area in which the mobile body is temporarily stopped or for which the mobile body is currently heading) and moves to the next area (virtual area or reference area). In the process of moving to the next area, the mobile body will pass through the designated area. When the mobile body does not have the right of passage, the mobile body will wait in the virtual area upstream of the designated area until acquiring the right of passage.

By taking AGV0 and AGV1 as an example, operation of mobile bodies will be described below.

AGV0 receives the first item of move command data shown in FIG. 19 and executes the instructions in the received move command data in sequence. AGV1 receives the second item of move command data shown in FIG. 19 and executes the instructions in the received move command data in sequence. Here, for the sake of explanation, it is assumed that after receiving move command data, AGV0 and AGV1 start executing instructions simultaneously.

### AGV0

AGV0 executes “SendRight(Na, AGV0)” and thereby gives the right of passage through Na to AGV0. AGV0 executes the instruction “Pa” next. Being already located in the area Pa, AGV0 executes the next instruction “Ia.” By executing the instruction “Ia,” AGV0 moves toward the virtual area Ia. Upon or before arriving at the virtual area Ia, AGV0 executes the next instruction “HaveRight(Na).” Having the right of passage through the designated area Na, AGV0 executes the next instruction “Ib.” By executing the instruction “Ib,” AGV0 heads toward the virtual area Ib. In the process of heading toward the virtual area Ib, AGV0 passes through the area Na. Upon arriving at the virtual area Ib, AGV0 executes the next instruction “SendRight(Na, AGV1)” and thereby gives the right of passage through the area Na to AGV1. Next, AGV0 executes the next instruction “Pb” and thereby moves to the area Pb. Upon arriving at the area Pb, AGV0 finishes operation. For example, AGV0 waits until next move command data is received from the operation planning apparatus 100.

### AGV1

AGV1, which executes an instruction “Pc” but is already located in the area Pc, executes the next instruction “Ic.” By executing the instruction “Ic,” AGV1 heads toward the virtual area Ic. Upon or before arriving at the virtual area Ic, AGV1 executes the next instruction “HaveRight(Na)” and thereby checks whether AGV1 has the right of passage through the area Na. If AGV1 has not yet acquired the right of passage, AGV1 temporarily stops at the virtual area Ic until acquiring the right of passage through Na. If AGV1 has acquired the right of passage through Na before arriving at Ic, or has acquired the right in Ic, AGV1 executes the next instruction “Id” and thereby heads toward the virtual area Id. Upon arriving at the virtual area Id, AGV1 executes the next instruction “SendRight(Na, NULL).” Since the ID of the mobile body is “NULL,” it is determined that there is no mobile body that will get the right of passage. In this case, the right of passage may be given up. Alternatively, the right of passage may be transmitted to the operation planning apparatus 100. In that case, the operation planning apparatus 100 can recognize that all the planned mobile bodies have passed through the designated area related to the right of passage. AGV1 executes the next instruction “Pd” and thereby moves to the area Pd. Upon arriving at the area Pd, AGV1 finishes operation. For example, AGV1 waits until next move command data is received from the operation planning apparatus 100.

FIG. 20 is a flowchart showing an operation example of a mobile body that has received move command data. The instruction executer 52 of the mobile body identifies the plurality of instructions in the move command data in sequence from the beginning. The instruction executer 52 checks the type of the identified instruction (S41). If the instruction is a move instruction, the mobile body moves to the area (reference area or virtual area) specified by the move instruction (S42). After the mobile body moves to the specified area, the instruction executer 52 determines whether all the instructions have been executed (S47). Note that when the mobile body is located at the initial departure point (start point), if the first instruction is an instruction to move to the start point, there is no need to move.

If it is determined in step S47 that not all the instructions have been executed (NO), the instruction executer 52 identifies the next instruction (S48) and returns to step S41. If all the instructions have been executed (YES), the instruction executer 52 finishes the present process.

If the identified instruction is not a move instruction (NO in S41), the instruction executer 52 determines whether the instruction is a give passage right instruction or a check passage right instruction with regard to a designated area (S43).

If the identified instruction is a give passage right instruction, the instruction executer 52 gives the right of passage through the designated area specified by the give passage right instruction to the mobile body specified by the give passage right instruction (S46). Then, the instruction executer 52 goes to step S45.

If the identified instruction is a check passage right instruction, the instruction executer 52 checks whether the mobile body has the right of passage through the designated area (S44). If the local mobile body passes through the designated area earlier than any other mobile body, the local mobile body already has the right of passage. In other cases, the instruction executer 52 determines whether the local mobile body has already acquired the right of passage through the designated area from another mobile body (already received data containing information that indicates the right of passage). When the local mobile body has the right of passage, the instruction executer 52 identifies the next instruction (S48) and returns to step S41.

According to the present embodiment, by giving and getting the right of passage through the designated area via communication among mobile bodies, contention among mobile bodies in the designated area can be prevented. For example, if the mobile body has not acquired the right of passage through the designated area, the mobile body can prevent contention by temporarily stopping at the virtual area upstream of the designated area. Also, by getting the right of passage before arriving at the virtual area upstream of the designated area, the mobile body can move to the designated area without stopping at the virtual area.

### Hardware Configuration

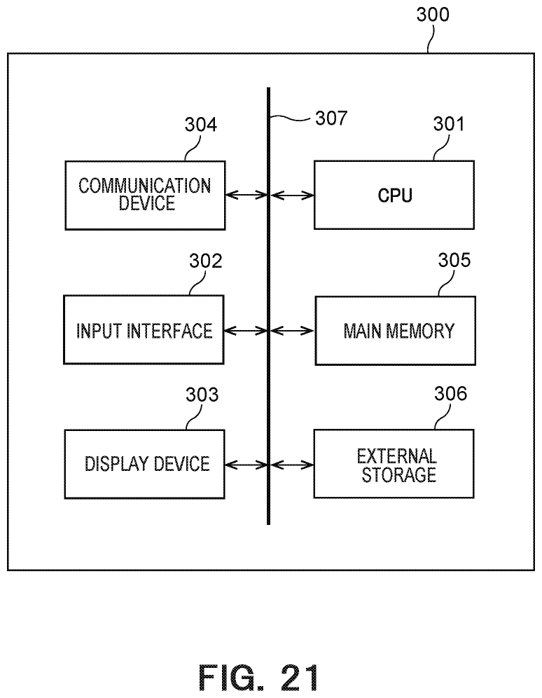

FIG. 21 illustrates a hardware configuration of the operation planning apparatus of FIG. 1 or FIG. 13 in the present approach. The operation planning apparatus of FIG. 1 is configured with a computer device 300. The computer device 300 includes a CPU301, an input interface 302, a display device 303, a communication device 304, a main storage device 305 and an external storage device 306, which are connected to each other with a bus 307.

The CPU (central processing unit) 301 executes a computer program (operation planning program or information processing program) on the main storage device 305. The program is a program which realizes the above-described respective functional components of the operation planning apparatus 100. Each functional component is realized by the CPU301 executing the program. The program does not have to be one program, and may be realized with combination of a plurality of programs or scripts. Each functional component is realized by the CPU 301 executing the program.

The input interface 302 is a circuit for inputting an operation signal from an input device such as a keyboard, a mouse and a touch panel to the operation planning apparatus 100.

The display device 303 displays data or information output from the operation planning apparatus 100. While the display device 303 is, for example, an LCD (Liquid Crystal Display), an organic electroluminescence display, a CRT (Cathode Ray Tube) or a PDP (Plasma Display Panel), the display device 303 is not limited to these. The data or information output from the computer device 300 can be displayed at this display device 303.

The communication device 304 is a circuit for the operation planning apparatus 100 to perform communication with an external device in a wireless or wired manner. Data can be input from the external device via the communication device 304. Information input from the external device can be stored in the main storage device 305 or the external storage device 306.

The main storage device 305 stores the program for realizing processing of the present approach, data necessary for execution of the program, data generated by execution of the program, or the like. The program is expanded on the main storage device 305 and executed. While the main storage device 305 is, for example, a RAM, a DRAM and an SRAM, the main storage device 305 is not limited to these. Each DB and each storage in FIG. 1 may be constructed on the main storage device 305.

The external storage device 306 stores the program, data necessary for execution of the program, data generated by execution of the program, or the like. These program and data are read out to the main storage device 305 in the processing of the present approach. While the external storage device 306 is, for example, a hard disk, an optical disk, a flash memory, and a magnetic tape, the external storage device 306 is not limited to these. Each DB and each storage in FIG. 1 may be constructed on the external storage device 306.

Note that the program may be installed in the computer device 300 in advance or may be stored in a storage medium such as a CD-ROM. Further, the program may be uploaded on the Internet.

The computer device 300 may be provided with one or more processors 301, input interfaces 302, display devices 303, communication devices 304 and main memories 305, and peripheral equipment such as a printer and a scanner may be connected to the computer device 300.

Further, the computer device 300 may be configured with a single computer device 300 or may be configured as a system including a plurality of computer devices 300 which are connected to each other. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A travel control apparatus comprising:
a move command data generator configured to acquire a travel route of a first mobile body in a travel area that includes a plurality of first areas and one or more second areas set on at least one of a plurality of travel paths provided among the plurality of first areas, and passing sequence information that defines a sequence in which a plurality of mobile bodies including the first mobile body passes through the first areas included in the travel route, and identify a third area, which is one of the second areas that is located ahead of the first areas on the travel route, and generate move command data for the first mobile body based on the third area and the passing sequence information; and
a communicator configured to transmit the move command data to the first mobile body.

2. The travel control apparatus according to claim 1, wherein the move command data includes:
a first instruction to move to the third area;
a second instruction to check with the travel control apparatus whether passage through the first areas is permitted; and
a third instruction to pass through the third area when passage through the first areas is permitted.

3. The travel control apparatus according to claim 1, wherein the move command data generator identifies a fourth area, which is one of the second areas that is located behind the first areas on the travel route, and generates the move command data using the fourth area and the third area.

4. The travel control apparatus according to claim 3, wherein the move command data includes:
a first instruction to move to the third area;
a second instruction to check with the travel control apparatus whether passage through the first areas is permitted;
a third instruction to move to the fourth area when passage through the first areas is permitted; and
a fourth instruction to transmit information to the travel control apparatus, indicating that the first areas are passed, upon arrival at the fourth area.

5. The travel control apparatus according to claim 2, further comprising a travel controller configured to receive inquiry data regarding whether the mobile body is permitted to pass through the first areas from the first mobile body executing the second instruction, and determine, based on the passing sequence information, whether to permit passage of the first mobile body, wherein
when passage of the first mobile body is permitted, the travel controller transmits a passage permission notice to the first mobile body.

6. The travel control apparatus according to claim 4, further comprising a travel controller configured to receive inquiry data regarding whether the mobile body is permitted to pass through the first areas from the first mobile body executing the second instruction, and determine, based on the passing sequence information, whether to permit passage of the first mobile body, wherein
when passage of the first mobile body is permitted, the travel controller transmits a passage permission notice to the first mobile body, and when a passage-complete notice is received from the first mobile body executing the fourth instruction, the notice indicating passage of the first mobile body through the first areas, the travel controller determines that passage of the first mobile body through the first areas is complete.

7. The travel control apparatus according to claim 3, wherein the move command data includes:
a first instruction to move to the third area;
a second instruction to check whether a right of passage through the first areas is already acquired from a second mobile body;
a third instruction to move to the fourth area when the right of passage is already acquired; and
a fourth instruction to give a third mobile body the right of passage after moving to the fourth area.

8. The travel control apparatus according to claim 1, wherein the travel path on which the third area is set is coupled to the first areas.

9. The travel control apparatus according to claim 1, wherein the first mobile body is an autonomous mobile body.

10. A mobile body comprising:
a travel controller configured to control travel in a travel area including a plurality of first areas and one or more second areas set on at least one of a plurality of travel paths provided among the plurality of first areas; and
a communicator capable of communicating with a travel control apparatus configured to control travel of a plurality of mobile bodies or with at least one of the plurality of mobile bodies, wherein
the travel controller:
checks whether the first areas are passable, based on communication with the travel control apparatus or with a first mobile body set to pass through the first areas earlier than the mobile body; and
controls the mobile body so as to pass through the third area when the first areas are passable and so as not to pass through the third area until the first areas become passable when the first areas are not passable, where the third area is one of the second areas that is located ahead of the first areas on the travel route of the mobile body.

11. The mobile body according to claim 10, further comprising a passage right processor configured to acquire a right of passage through the first areas from the first mobile body, wherein:
the travel controller performs control such that the mobile body does not pass through the third area until the right of passage is acquired and that the mobile body passes through the third area after the right of passage is acquired from the first mobile body; and
the passage right processor gives a second mobile body the right of passage after at least the mobile body passes through the first areas.

12. The mobile body according to claim 11, wherein the passage right processor gives the second mobile body the right of passage after the mobile body moves to a fourth area, which is one of the second areas that is located behind the first areas on the travel route.

13. The mobile body according to claim 11, wherein when the right of passage is not yet acquired at a time of arrival at the third area, the travel controller stops the mobile body at the third area until the right of passage is acquired.

14. The mobile body according to claim 11, wherein when the right of passage is already acquired before arrival at the third area, the travel controller makes the mobile body pass through the third area without stopping at the third area.

15. The mobile body according to claim 12, further comprising an instruction executer configured to:
receive the move command data including:
a first instruction to move to the third area,
a second instruction to check whether the right of passage is already acquired from the first mobile body,
a third instruction to move to the fourth area when the right of passage is already acquired, and
a fourth instruction to give the second mobile body the right of passage after moving to the fourth area; and
execute the first to fourth instructions included in the move command data.

16. The mobile body according to claim 15, wherein:
the travel controller controls the mobile body so as to stop at the third area; and
the instruction executer executes the second instruction with the mobile body stopped in the third area.

17. The mobile body according to claim 15, wherein:
the instruction executer executes the second instruction before the mobile body arrives at the third area; and
when it is confirmed that the right of passage is already acquired by the mobile body before the mobile body arrives at the third area, the travel controller makes the mobile body pass through the third area without stopping at the third area.

18. The mobile body according to claim 10, wherein the travel controller:
checks with the travel control apparatus whether the mobile body is permitted to pass through the first areas; and
controls the mobile body so as to pass through the third area when the mobile body is permitted to pass through the first areas by the travel control apparatus.

19. The mobile body according to claim 10, wherein after the mobile body moves to a fourth area, which is one of the second areas that is located behind the first areas on the travel route, the travel controller transmits information to the travel control apparatus, indicating that the first areas are passed.

20. The mobile body according to claim 18, wherein when passage through the first areas is not permitted by the travel control apparatus at a time of arrival at the third area, the travel controller makes the mobile body stop in the third area until passage through the first areas is permitted.

21. The mobile body according to claim 18, wherein when passage through the first areas is permitted before arrival at the third area, the travel controller controls the mobile body so as to pass through the third area without stopping at the third area.

22. The mobile body according to claim 10, further comprising an instruction executer configured to:
receive the move command data including:
a first instruction to move to the third area,
a second instruction to check with the travel control apparatus whether the mobile body is permitted to pass through the first areas,
a third instruction to pass through the third area when passage through the first areas is permitted; and
execute the first to third instructions included in the move command data.

23. The mobile body according to claim 22, wherein:
the third instruction instructs the mobile body to move to a fourth area, which is one of the second areas that is located behind the first areas on the travel route;
the move command data includes a fourth instruction to transmit information to the travel control apparatus, indicating that the first areas are passed, after the mobile body moves to the fourth area; and
the instruction executer executes the fourth instruction.

24. The mobile body according to claim 22, wherein:
the travel controller controls the mobile body so as to stop at the third area; and
the instruction executer executes the second instruction with the mobile body stopped in the third area.

25. The mobile body according to claim 22, wherein:
the instruction executer executes the second instruction before the mobile body arrives at the third area; and
when passage through the first areas is permitted before the mobile body arrives at the third area, the travel controller makes the mobile body pass through the third area without stopping at the third area.

26. The mobile body according to claim 10, wherein the travel path on which the third area is set is coupled to the first areas.

27. The mobile body according to claim 10, wherein the mobile body is an autonomous mobile body.

28. An operation system comprising a travel control apparatus and a first mobile body, wherein:
the travel control apparatus includes:
a move command data generator configured to acquire passing sequence information that indicates a passing sequence of a plurality of mobile bodies in a plurality of first areas passed by a plurality of mobile bodies in common on travel routes of the plurality of mobile bodies in a travel area that includes the plurality of first areas and one or more second areas set on at least one of a plurality of travel paths provided among the plurality of first areas, and generate move command data for the first mobile body based on the third area and the passing sequence information, where the third area is one of the second areas that is set on a travel path of the first mobile body on a travel route of the first mobile body out of the plurality of mobile bodies; and
a communicator configured to transmit the move command data to the first mobile body; and
the first mobile body includes:
a communicator configured to receive the move command data, and
a travel controller configured to make the first mobile body travel in the travel area, based on the move command data.
